(19) United States
(12) Patent Application Publication
(10) Pub. No.: US 2014/0171062 A1
(43) Pub. Date: Jun. 19, 2014

(54) Wireless Devices, Network Node and Methods for Handling Relay Assistance in a Wireless Communications Network

(71) Applicant: Telefonaktiebolaget L M Ericsson (publ), Stockholm (SE)

(72) Inventors: Mikael Fallgren, Stockholm (SE); Gabor Fodor, Hasselby (SE); Per Skillermark, Arsta (SE)

(73) Assignee: Telefonaktiebolaget L M Ericsson (publ), Stockholm (SE)

(21) Appl. No.: 13/882,690

(22) PCT Filed: Apr. 4, 2013
(86) PCT No.: PCT/SE2013/050370

§ 371 Date: Apr. 30, 2013

Related U.S. Application Data
(60) Provisional application No. 61/739,048, filed on Dec. 19, 2012.

(51) Int. Cl. H04W 40/22

(52) U.S. Cl. CPC H04W 40/22
USPC 455/422.1

(57) ABSTRACT

A method in a second wireless device for handling relay assistance from a first wireless device in a wireless network is provided. The second wireless device sends (202) a first beacon signal to the first wireless device, which first beacon signal advertises that the second wireless device needs relay assistance in a radio communication, and/or the second wireless device receives (203) a second beacon signal from the first wireless device, which second beacon signal advertises that the first wireless device provides relay assistance in a radio communication in the wireless network. The second wireless device then configures (209) a Device to Device, D2D, bearer between the first wireless device and the second wireless device based on the first beacon signal and/or the second beacon signal. This enables said communication to be performed via the D2D bearer wherein the first wireless device acts as a relay node.

### TECHNICAL FIELD

Embodiments herein relate to a first wireless device, a second wireless device, a network node and methods therein. In particular, it relates to handling relay assistance.

### BACKGROUND

Communication devices such as wireless devices are also known as e.g. User Equipments (UEs), terminals, mobile terminals, wireless terminals and/or mobile stations. Wireless devices are enabled to communicate wirelessly in a cellular communications network or wireless communications networks, sometimes also referred to as a cellular radio system or cellular networks. The communication may be performed e.g. between two wireless devices, between a wireless device and a regular telephone and/or between a wireless device and a server via a Radio Access Network (RAN) and possibly one or more core networks, comprised within the cellular communications network.

Wireless device may further be referred to as mobile telephones, cellular telephones, laptops, or surf plates with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The cellular communications network covers a geographical area which is divided into cell areas, wherein each cell area being served by a base station, e.g. a Radio Base Station (RBS), which sometimes may be referred to as e.g. “eNB”, “eNodeB”, “NodeB”, “B node”, or BTS (Base Transceiver Station), depending on the technology and terminology used. The base stations may be of different classes such as e.g. macro eNodeB, home eNodeB or pico base station, based on transmission power and thereby also cell size. A cell is the geographical area where radio coverage is provided by the base station at a base station site. One base station, situated on the base station site, may serve one or several cells. Further, each base station may support one or several communication technologies. The base stations communicate over the air interface operating on radio frequencies with the wireless devices within range of the base stations. In the context of this disclosure, the expression Downlink (DL) is used for the transmission path from the base station to the user equipment. The expression Uplink (UL) is used for the transmission path in the opposite direction i.e. from the user equipment to the base station.

In 3rd Generation Partnership Project (3GPP) Long Term Evolution (LTE), base stations, which may be referred to as eNodeBs or even eNBs, may be directly connected to one or more core networks.

UMTS is a third generation mobile communication system, which evolved from the GSM, and is intended to provide improved mobile communication services based on Wideband Code Division Multiple Access (WCDMA) access technology. UMTS Terrestrial Radio Access Network (UTRAN) is essentially a radio access network using wideband code division multiple access for user equipments. The 3GPP has undertaken to evolve further the UTRAN and GSM based radio access network technologies.

3GPP LTE radio access standard has been written in order to support high bitrates and low latency both for uplink and downlink traffic. All data transmission is in LTE controlled by the radio base station.

Device-to-Device Communication in Cellular Spectrum

Device-to-device communications in cellular spectrum is a relatively new concept that targets scenarios in which communicating parties are in the close proximity of each other. Such communication may be assisted by the cellular network infrastructure when it is available, or it may take place in an ad hoc and autonomous fashion in case the cellular network is damaged. Specifically, in 3GPP LTE networks, such LTE Direct communication may be used in commercial applications, such as proximity based social networking or in public safety situations in which first responders need to communicate with each other and with people in the disaster area.

An important functionality in NetWork (NW) assisted D2D communication is Mode Selection (MS) that determines whether wireless devices in the proximity of each other should communicate via a direct link or through a cellular base station or access point. In existing technology, the MS algorithms are based on radio resource availability, propagation conditions, network load and other low layer aspects. Existing MS algorithms tend to select the D2D mode, i.e. direct mode for wireless devices that are in the proximity of each other and are far apart from cellular access points and user equipments so that the interference level caused to cellular nodes by D2D nodes can be kept at suitably low levels.

Existing MS algorithms are typically based on the radio distance between the wireless devices and the access point and take into account radio conditions, energy efficiency targets, power constraints, interference caused by D2D links to the cellular users and resource availability.

Neighbor device discovery algorithms or sometimes called peer device discovery algorithms or simply neighbor discovery algorithms serve the purpose of allowing wireless devices in the vicinity of one another to discover each other's presence and obtain information about the radio channel in between them. This is typically achieved by devices broadcasting and detecting so called beacon signals, sometimes called reference signals. The broadcasting and detecting of such beacon signals may also serve secondary purposes such as devices obtaining synchronization

Cooperative Communications and Relaying Technologies

Cooperative communications by means of relaying have been studied and in some forms also used in cellular networks. The advantages of relay based cooperative communications over communications without relay based cooperation include performance gains, including coverage improvements, balanced quality of service and reduced infrastructure deployment costs. Because of these advantages, the research and engineering community has developed a number of relaying protocols, including transparent relaying, such as Amplify and Forward (AF), Linear process and Forward (LF) and non-Linear Process and forward (nLF), and regenerative relaying protocols. Examples of this latter category, i.e. regenerative relaying protocols, are Estimate and Forward (EF), Compress and Forward (CF), Decode and Forward (DF), Purge and Forward (PF), and Gather and Forward (GF). More information on different relaying protocols is provided below.

Cooperative communications in general and employing relaying in cellular and adhoc networks in particular allow wireless devices and infrastructure nodes of act jointly for a common goal, such as extending coverage, enhancing user bit rates, improve energy efficiency and communication reliability, etc.

A problem with existing neighbor discovery techniques is that they do not allow a wireless device to find other wireless devices with specific relaying capabilities and willingness to help.

WO 2012/118265 A1, a method and apparatus for transmitting data in a wireless communications system, discloses one way of solving the problem. It describes a means for how one UE, here referred to as the ‘helper UE’, may assist another UE, here referred to as the ‘UE in need of assistance’ during uplink communication with the access point. In the first phase the UE in need of assistance transmits a data packet intended for the access point. The helper UE overhears this transmission, and if the packet transmission is unsuccessful the helper UE takes part in the retransmission of the packet. The helper UE hence relays between a UE in need of assistance and the access point when retransmitting the packet. A disadvantage with this solution is that the helper UE must overhear all possible transmissions, even from UEs that are not in need of assistance, or determine autonomously if this is a UE in need of assistance. Hence, this solution is very heavy and inefficient for potential helpers as they need to receive all ongoing packet transmissions, and retransmit all packet retransmissions.

U.S. Pat. No. 8,275,308 B2, method for relaying between a base station and mobile station, discloses another way of solving the problem. In this document relay stations take part in the retransmission of erroneous packets, just like in WO 2012/118265 A1 above, and a mutual cooperation manager is used to organize the retransmissions. The mutual cooperation manager is located in the relay station and holds a list to all UEs whose transmissions the relay station can decode. During operation the relay station decodes and stores temporarily all packets associated with the UEs on the mutual cooperation list. Furthermore, the mutual cooperation list is made available to the base station, and when a packet error occurs the base station checks if the source UE is on any of the mutual cooperation lists. When the UE is found on any of the mutual cooperation lists the base station schedules the packet retransmission from the relay station rather than from the UE. A disadvantage with this solution is similar as the prior art above, but here the helper is a fixed relay and a mutual cooperation manager is used. Also, here all retransmissions are handled via the helper. The helper must listen to and decode all transmissions from UEs it can hear, perhaps it may afford this from an energy consumption point of view if it is connected to a power grid. But this may not be feasible in the case when the UE is mobile, due to excessive power consumption.

### SUMMARY

It is therefore an object of embodiments herein to provide a way of improving the way of handling relay assistance between wireless devices.

According to a first aspect, the object is achieved by a method in a second wireless device for handling relay assistance from a first wireless device in a wireless network. The second wireless device sends a first beacon signal to the first wireless device, which first beacon signal advertises that the second wireless device needs relay assistance in a radio communication, and/or the second wireless device receives a second beacon signal from the first wireless device, which second beacon signal advertises that the first wireless device provides relay assistance in a radio communication in the wireless network. The second wireless device then configures a Device to Device, D2D, bearer between the first wireless device and the second wireless device based on the first beacon signal and/or the second beacon signal. This enables said communication to be performed via the D2D bearer wherein the first wireless device acts as a relay node.

According to a second aspect, the object is achieved by a method in a network node for handling relay assistance by a first wireless device to a second wireless device in a wireless network. The second wireless device needs relay assistance in a radio communication. The network node receives one or more reports from the first wireless device and/or the second wireless device. The one or more reports comprise a respective measurement of a beacon signal sent between the first wireless device and the second wireless device. When the measurement in the one or more reports exceeds a threshold, the network node sends to the first wireless device and the second wireless device, a configuration of a Device to Device, D2D, bearer between the first wireless device and the second wireless device, enabling said communication to be performed via the D2D bearer wherein the first wireless device acts as a relay node.

According to a third aspect, the object is achieved by a method in a first wireless device for handling relay assistance for a second wireless device in a wireless network. The first wireless device receives a first beacon signal from the second wireless device, which first beacon signal advertises that the second wireless device needs relay assistance in a radio communication, and/or the first wireless device sends a second beacon signal to be received by the second wireless device, which second beacon signal advertises that the first wireless device has capability to provide relay assistance in a radio communication in the wireless network. The first wireless device then configures a Device to Device, D2D, bearer between the first wireless device and the second wireless device based on the first beacon signal and/or the second beacon signal. This enables said radio communication to be performed via the D2D bearer wherein the first wireless device acts as a relay node.

According to a fourth aspect, the object is achieved by a second wireless device for handling relay assistance from a first wireless device in a wireless network. The second wireless device comprising at least one of a sending unit adapted to send a first beacon signal to the first wireless device, which first beacon signal advertises that the second wireless device needs relay assistance in a radio communication, and a receiving unit adapted to receive a second beacon signal from the first wireless device, which second beacon signal advertises that the first wireless device provides relay assistance in a radio communication in the wireless network.

The second wireless device comprises a configuring unit adapted to configure a Device to Device, D2D, bearer between the first wireless device and the second wireless device based on the first beacon signal and/or the second beacon signal, enabling said communication to be performed via the D2D bearer wherein the first wireless device acts as a relay node.

According to a fifth aspect, the object is achieved by a network node for handling relay assistance by a first wireless device to a second wireless device in a wireless network. The second wireless device needs relay assistance in a radio communication. The network node comprises a receiving unit adapted to receive one or more reports from the first wireless device and/or the second wireless device. The one or more reports comprise a respective measurement of a beacon signal sent between the first wireless device and the second wireless device. The network node further comprises a sending unit adapted to, when the measurement in the one or more reports exceeds a threshold, send to the first wireless device and the second wireless device, a configuration of a Device to Device, D2D, bearer between the first wireless device and the second wireless device. This enables said communication to be performed via the D2D bearer wherein the first wireless device acts as a relay node.

According to a sixth aspect, the object is achieved by a first wireless device for handling relay assistance for a second wireless device in a wireless network. The first wireless device comprising at least one of a receiving unit adapted to receive a first beacon signal from the second wireless device, which first beacon signal advertises that the second wireless device needs relay assistance in a radio communication, and a sending unit adapted to send a second beacon signal to be received by the second wireless device, which second beacon signal advertises that the first wireless device has capability to provide relay assistance in a radio communication in the wireless network.

The first wireless device further comprises a configuring unit adapted to configure a Device to Device, D2D, bearer between the first wireless device and the second wireless device based on the first beacon signal and/or the second beacon signal. This enables said radio communication to be performed via the D2D bearer wherein the first wireless device acts as a relay node.

Since beacon signals are signalled by the first wireless device and/or the second wireless device , advertising that the first wireless device has capability to provide relay assistance, and/or that the second wireless device needs relay assistance, a helping device such as the first wireless device can be identified of act as a relay node for the second wireless device. In this way the way of handling relay assistance between wireless devices has been improved.

### DETAILED DESCRIPTION

As part of developing embodiments herein, a problem will first be identified and discussed.

As mentioned above, due to the evolving D2D technology and relaying capabilities of UEs i.e. wireless devices, D2D technology has the potential to improve the cellular coverage and enhance data rates of cell edge wireless devices. So far D2D technology development has, however, primarily been focused on data transfers between two wireless devices, and not on the situation when D2D communication is used in the form of relaying to improve the communication between a wireless device and an access point such as a base station.

Consequently, existing neighbor discovery techniques do not allow a wireless device to find other wireless devices with specific relaying capabilities and willingness to help;
Existing neighbor discovery techniques do not allow wireless devices to advertise their capabilities, and in particular the relaying capabilities, and willingness to assist cell edge wireless devices, as well as cell edge wireless devices cannot advertise their need for assistance;
Existing bearer establishment and D2D pairing algorithms do not facilitate the selection of wireless devices in a geographic proximity of a given wireless device based on their capabilities, current radio conditions and willingness to assist the cell edge wireless devices;

In short, existing technologies do not provide support for neighbor discovery and D2D communications for the specific purpose of improving the cell edge performance in cellular networks.

In network assisted D2D communications, a fundamental problem is mode selection that has the task to decide on which mode two wireless devices residing in the same cell or neighboring cells should communicate with one another. According to embodiments herein, this general problem is broken down and extended to the following two sub-problems.

Problem 1:

How should a given help needing wireless device and/or the cellular network find, i.e. identify, helper wireless devices in the said cellular network that are capable of and willing to provide proper relaying functionality to assist the said help needing wireless device in the said cellular network in order to improve coverage, increase cell edge bit rate, and/or reduce the amount of retransmissions of the help needing wireless device?

Problem 2:

How to allow the help needing wireless device that has found such helper, i.e. wireless devices willing to relay, to select a subset, possibly only one, out of the helper wireless devices, identified in Problem 1, to actually provide the relaying functionality for the cell edge wireless devices?

In this problem, an underlying hidden related problem is the issue of how to select and configure the type of relaying between the selected helper wireless device and the cellular network's access point or Base Station/network node (BS/eNB).

A concept of some embodiments herein is to use a combination of special advertising and network assistance to solve Problem 1 and Problem 2 above and in particular to facilitate relaying assistance by one helper UE to another UE in the same cell.

According to some embodiments herein, a D2D mode selection comprises three steps: advertising, network assisted matching and D2D bearer configuration.

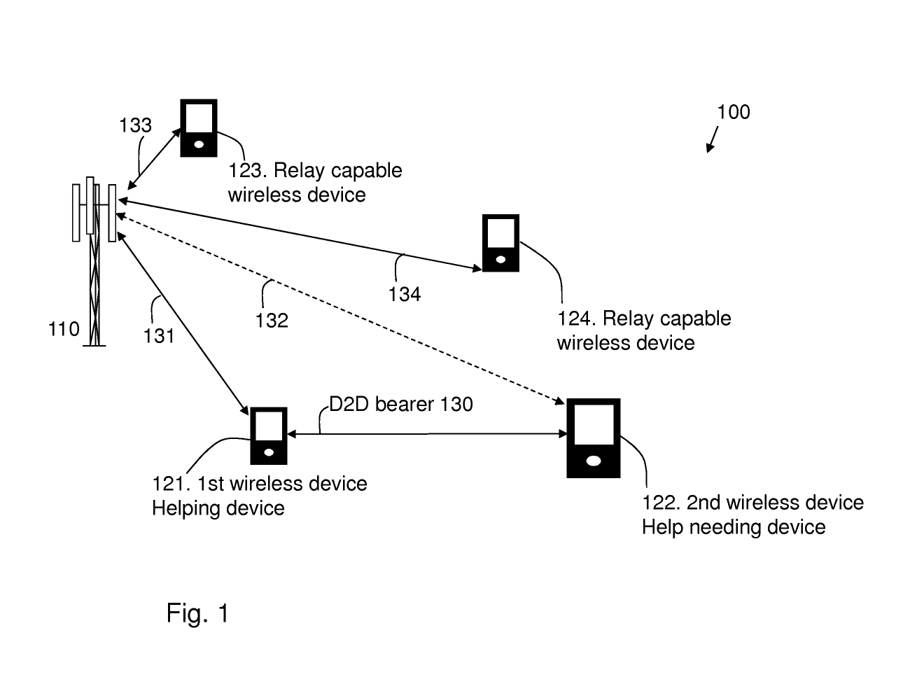

A helper UE is referred to as a first wireless device 121 in embodiments herein. The UE being helped is referred to as a second wireless device 122 herein. The first wireless device 121 and the second wireless device 122 will be described with reference to FIG. 1 below. During advertising, D2D Capable UEs such as a first wireless device 121 may use a periodic beaconing procedure to advertise their relaying and D2D capabilities as well as a summary of their current radio measurements related to the current serving cell e.g. based on Reference Signal Received Power (RSRP) and Received Signal Strength Indicator (RSSI), to let other UEs such as the second wireless device 122, in their neighborhood, e.g. up to a couple of 100 meters, learn that they are capable of and willing of acting as transparent or regenerative relay, e.g. Amplify-Forward, Decode-Forward, . . . nodes to other UEs such as the second wireless device 122. D2D Capable UEs such as the second wireless device 122, that experience low Signal to Interference plus Noise Ratio (SINR) and high path loss, use a periodic beaconing procedure to advertise the need for relaying assistance, optionally also advertising the type of help they need, e.g. increase bit rate or preserve coverage or reduce retransmissions.

During the matching step, UEs that identified each other as helpers and UEs that need help respectively such as the first wireless device 121 and the second wireless device 122 may use network assistance to establish D2D communications in cellular spectrum. In this matching step the UEs and the NW such as the network node 110 may have different roles, but according to embodiments herein, there is an interplay between the NW and the involved UEs.

After proper bearer configuration, the assisting UE(s) such as the second wireless device 122 takes part in the transmission phase of the communication to improve the effective overall link quality. The bearer configuration has the responsibility to properly select relaying modes and set associated parameters for the particular relay mode.

FIG. 1 depicts a wireless communications network 100 in which embodiments herein may be implemented. In some embodiments the wireless communications network 100 may be a communication network such as an LTE (e.g. LTE FDD, LTE TDD, LTE), WCDMA, UTRA TDD, GSM network, Enhanced Data Rate for GSM Evolution (EDGE) network, GSM EDGE Radio Access Network (GERAN) network, High Speed Packet Access (HSPA), Wireless Local Area network (WLAN), any network comprising of any combination of RATs such as e.g. Multi-Standard Radio (MSR) base stations, multi-RAT base stations etc., any 3GPP cellular network, Wimax, or any cellular network or system.

The wireless communications network 100 comprises a network node 110, which network node 110 in some embodiments serves the first wireless device 121 and the second wireless devices 122. The network node 110 may be a radio base station such as e.g. an eNB, an eNodeB, or a Home Node B, a Home eNode B or any other network node or access point capable to serve a wireless device such as a user equipment and/or a machine type communication device in a wireless communications network. Please note that the network node 110 is also referred to as the network, the NW, the Base Station, the BS, or the eNB in this document.

A number of wireless devices are located in the wireless communications network 100. In the example scenario of FIG. 1, the first wireless device 121 and the second wireless device 122, are located in the wireless communications network 100. The wireless communications network 100 further comprises one or more further wireless devices 123, 124, in the example scenario of FIG. 1, two wireless devises are shown. The first wireless device 121, the second wireless device 122 and the one or more further wireless devices 123, 124 are capable to communicate using D2D communication. The first wireless device 121 may e.g. communicate with the second wireless device 122 using D2D communication over a D2D bearer 130. The first wireless device 121 is adapted to communicate with the network node 110 over a first radio link 131. The second wireless device 122 is adapted to communicate with the network node 110 over a second radio link 132. The one or more further devices 123, 124 are adapted to communicate with the network node 110 over one or more respective radio links 133, 134. As mentioned above, the helper UE that is capable of acting as a relay node is referred to as the first wireless device 121 and the UE being helped, i.e. that need relay assistance is referred to as the second wireless device 122 herein. The one or more further wireless devices 123, 124 are D2D capable and capable of acting as relay nodes and may be candidates to help the first wireless device 121.

The first wireless device 121, the second wireless device 122, and the one or more further wireless devices 123, 124 may e.g. be mobile terminals or wireless terminals, mobile phones, computers such as e.g. laptops, Personal Digital Assistants (PDAs) or tablet computers, sometimes referred to as surf plates, with wireless capability, Machine to Machine (M2M) devices or any other radio network units capable to communicate over a radio link in a communications network.

Embodiments of a Method Seen from the Second Device 122 View

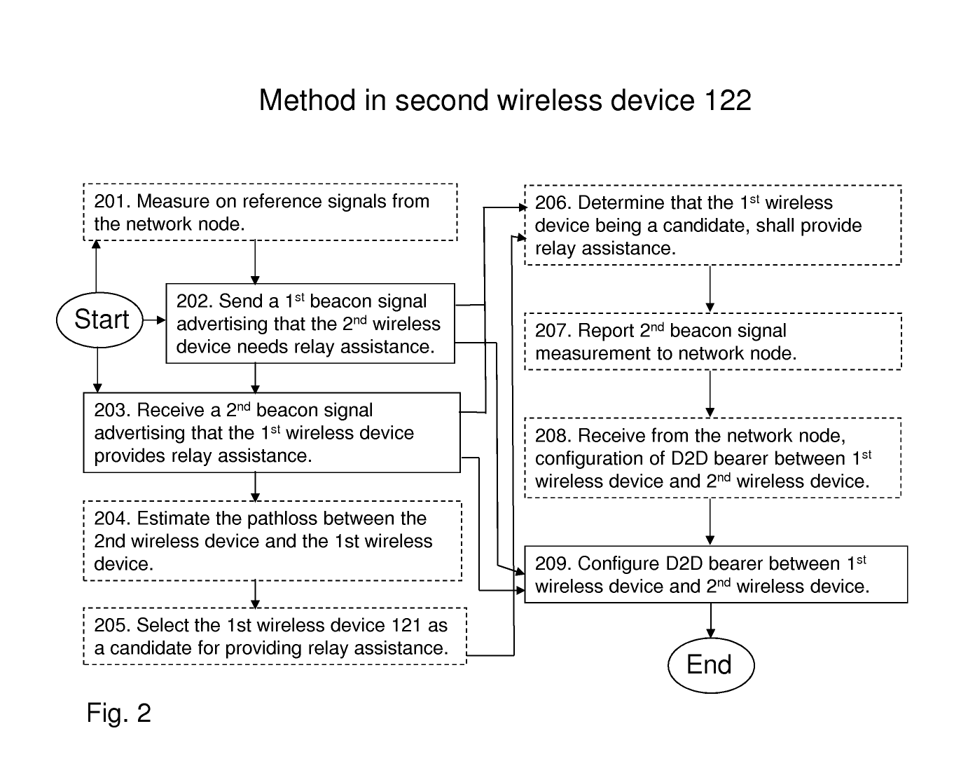

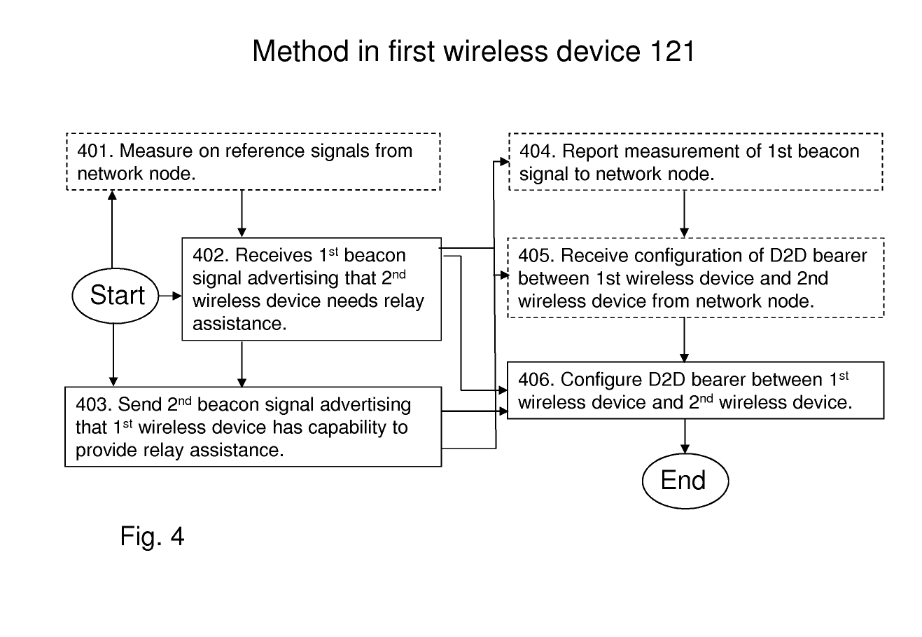

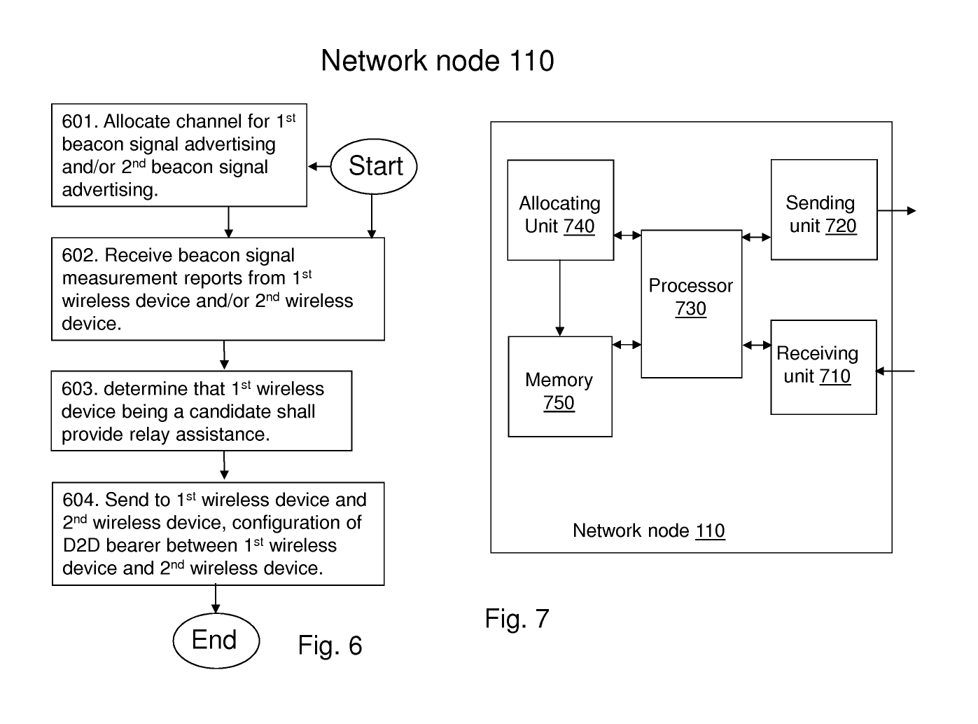

Firstly, in FIG. 2, embodiments of a method will be described when seen from the second wireless device 122 view. Afterwards, embodiments of the method when seen from the first wireless device 121 view (FIG. 4) and embodiments of the method when seen from the network node 110 view (FIG. 6) will be described.

Thus, example of embodiments of a method in a second wireless device 122 for handling relay assistance from a first wireless device 121 in a wireless network 100 will now be described with reference to a flowchart depicted in FIG. 2. According to an example scenario, the second wireless device 122 is served by or is camping on the network node 110, and is communicating with the network node 110 over the radio link 132. The second device 122, is the device that seeks for help. The method comprises the following actions, which actions may be taken in any suitable order. Dashed lines of some boxes in FIG. 2 indicate that this action is not mandatory.

Action 201

This action is optional .The second wireless device 122 checks the quality such as Quality of service (QoS) of the radio link 132. When the second wireless device 122 finds or believes that the link quality is getting poor, it realises that it would be helped if any wireless device in the neighbour of the second wireless device 122, having better link quality could act as a relay node. To check the quality of the radio link 132, the second wireless device 122 may measure on reference signals from the network node 110. These signals may be one or more out of a RSRP, Reference Signal Received Quality (RSRQ) and RSSI.

Action 202

The method comprises at least one of Action 202 and 203, i.e. it may in some embodiments also comprise both Action 202 and 203.

When the second wireless device 122 needs relay assistance, it may send a first beacon signal to the first wireless device 121. The first beacon signal advertises that the second wireless device 122 needs relay assistance in a radio communication. The first beacon signal is broadcasted so that any device, including the first wireless device 121, in the neighborhood of the second wireless device 122, i.e. in an area of radio coverage from the second wireless device 122, can receive it. This means that the first beacon signal is not specifically addressed to the first wireless device 121, but the first wireless device 121 as well as the one or more further wireless devices 123, 124 appearing in some embodiments, can hear the first beacon signal if they are located within an area of radio coverage from the second wireless device 122.

In some embodiments, this action of sending of the first beacon signal is performed when any one of the RSRP, RSSI, and/or RSRQ measurements performed in Action 201 falls below a threshold.

As mentioned above, in some embodiments needing D2D Capable UEs such as the second wireless device 122 whose RSRP, RSSI and/or RSRQ measurements indicate risk of failure, may construct a beacon signal such as the first beacon signal and start advertising its need of help. The indicated risk of failure, may e.g. be cell edge situation or risk for outage and/or Radio Link Failure (RLF) of the radio link 132. When the second wireless device 122 is located at a cell edge, the radio link 132 may be poor compared to a location of the second wireless device closer to the network node 110. Outage means that requirements of QoS of the radio link is not met.

The first beacon signal may comprise information about any one or more out of: -preferred relay types of the second wireless device 122, e.g. type of relay such as AF, LF, DF, CF, EF, or GF. See definitions in the end of the description.

incentive of assisting the second wireless device 122,

type of help needed by the second wireless device 122, such as e.g. type of relay assistance the second wireless device 122 is looking for. Further, e.g. purpose of help that the second wireless device 122 is looking for, e.g. improve Bit Error rate (BER) of system information, improve downlink/uplink bit rate, reduce uplink transmit power, improve uplink Hybrid Automatic Repeat reQuest (HARQ), performance;

If available position information of the second wireless device 122.

If available velocity information of the second wireless device 122.

UE capability information of the second wireless device 122.

group identity of the second wireless device 122, such as Groups IDs in which the second wireless device is a member of, e.g. Buddy List or Social Network Group it belongs to./What is a Buddy list?

Home operator and/or visited operator of the second wireless device 122.

Estimated downlink and uplink data rates from/to the access point, such as e.g. the network node 110.

Incentive that the second wireless device 122 is willing to provide to the helping device to get relaying assistance from the helper device such as e.g. content, charging reduction (that is the help needing device is willing to be charged for getting help which charge can reduce the charges imposed on the helper device), or indication of willingness of helping the helping device at a future possible occasion.

The second wireless device 122 may also send a registration message to the network node 110 in connected mode, or to a Mobility Management Entity (MME) in a Tracking Area (TA) when being in idle mode with similar content as the first beacon signal.

The duty cycle of the first beacon signal may be determined by the network such as e.g. the network node 110 or be autonomously adjusted by the second wireless device 122 based on, e.g. its battery status.

Action 203

As an alternative to or in combination with Action 202, the second wireless device 122 may receive a second beacon signal from the first wireless device 121. The second beacon signal advertises that the first wireless device 121 provides relay assistance in a radio communication in the wireless network 100.

The second beacon signal is broadcasted by the first wireless device 121 so that any device, including the second wireless device 122, in the neighborhood of the first wireless device 121, i.e. in an area of radio coverage from the first wireless device 121, can receive it. This means that the second beacon signal is not specifically addressed to the second wireless device 122, but the second wireless device 122 can hear the first beacon signal if it is located within an area of radio coverage from the first wireless device 121.

However, there may be other wireless devices in the neighbourhood of the second wireless device 122 that are capable of providing relay assistance. Therefore in some embodiments, this action further comprises receiving one or more further second beacon signals from the respective one or more further wireless devices 123,124. The respective one or more further second beacon signals advertises that the respective one or more further wireless devices 123,124 provide relay assistance in the radio communication in the wireless network 100.

The second beacon signal or signals may each comprise information about any one or more out of: link quality and/or signal strength to serving network node, relaying capability of the first wireless device 121, position information of the first wireless device 121, velocity information of the first wireless device 121, UE capability information of the first wireless device 121, group identity of the first wireless device 121, home operator of the first wireless device 121, visited operator of the first wireless device 121.

Action 204

This action is optional. The second wireless device 122 may have sent the first beacon signal and received an answer to the first beacon signal from the first device 121 and/or the other wireless devices 123, 124 that it/they may provide relay assistance to the second wireless device 122. As an alternative or as combined, the second wireless device 122 may have heard the second beacon signal from the first wireless device 121 and/or the other second beacon signals from the respective other wireless device 123, 124. So by sending first beacon signals or by receiving second signals the second wireless device 122 may have identified candidates, such as the first wireless device 121, and/or the respective other wireless device 123, 124, that may provide relay assistance to the second wireless device 122.

According to some embodiments, to see if the first wireless device 121 offers better route to the network node 110 then the route from the second wireless device 122 direct to the network node 110, the second wireless device 122 may estimate the pathloss between the second wireless device 122 and the first wireless device 121 on the second beacons signal. The second wireless device 122 may further estimate the pathloss between second wireless device 122 and the network node 110.

Pathloss is the signal attenuation between a transmitter and a receiver. The pathloss to the first wireless device 121 may be estimated e.g. based on RSRP and/or RSSI measurements, and the pathloss to the network node 110 may be estimated e.g. based on RSRP and/or RSSI measurements on a reference signal sent by the network node 110.

In some embodiments, the second wireless device 122 have received second beacon signals from multiple wireless devices providing relay assistance. In one example, the second wireless device 122 have received second beacon signals from the first wireless device 121, and the one or more further wireless devices 123,124. To have a base for selecting the wireless device that offers the best relay in these embodiments, the second wireless device 122 may further estimate the pathloss between the second wireless device 122 and the respective one or more further wireless devices 123,124 on the respective second beacons signals,

This means that in this specific example the second wireless device 122 estimates:
the pathloss between second wireless device 122 and the network node 110,
the pathloss between second wireless device 122 and the first wireless device 121,
the pathloss between second wireless device 122 and the wireless device 123, and
the pathloss between second wireless device 122 and the wireless device 124.

The different wireless devices 121, 123, 124 may be entered into a list of candidates offering relay assistance.

Action 205

This action is optional. According to some embodiments, when the estimated pathloss between the second wireless device 122 and the first wireless device 121 is lower compared to the estimated pathloss between the second wireless device 122 and the network node 110, the second wireless device 122 selects the first wireless device 121 as a candidate for providing relay assistance.

In the embodiments wherein the second wireless device 122 have received second beacon signals from multiple wireless devices providing relay assistance, when the estimated pathloss between the second wireless device 122 and any of the respective first wireless device 121 and/or one or more further wireless devices 123,124 are lower compared to the estimated pathloss between the second wireless device 122 and the network node 110, the second wireless device 122 selects these any of the respective first wireless device 121 and/or one or more further wireless devices 123,124 as a respective candidate 121, 123, 124 for providing relay assistance.

This means that the second wireless device 122 selects any wireless device that offers a better route than the direct route between the second wireless device 122 and the network node 110 as a candidate for providing relay assistance. These are kept in the candidate list.

The second wireless device 122 removes any wireless device that offers a worse route than the direct route between the second wireless device 122 and the network node 110, from the candidate list. The results of the measured pathloss and/or the candidate list may be reported to network node 110, see below.

Action 206

This action is optional, since in some embodiments the determination of which wireless device that shall be acting as the relay node, may be performed by second wireless device 122 or in some other embodiments, the determination is made by the network node 110. The latter will be described below.

Therefore in some embodiments, the second wireless device 122 determines that the first wireless device 121 being a candidate, shall provide relay assistance, if the candidate provides a route, from the second wireless device 122 via the candidate to the network node 110, that has higher data rate than a route from the second wireless device 122 direct to network node 110.

In the embodiments wherein the second wireless device 122 have received second beacon signals from multiple wireless devices providing relay assistance, the candidates may be any of the first wireless device 121 or the other wireless devices 123, 124, referred to as candidates 121, 123, 124. In these embodiments, the second wireless device 122 determines that the candidate 121, 123, 124 that provides a route with the highest data rate shall provide relay assistance, which route is from the second wireless device 122 via the candidate 121, 123, 124 to the network node 110, if that candidate 121, 123, 124 provides a route that has higher data rate than a route from the second wireless device 122 direct to network node 110. From the beacon signal the second wireless device 122 knows the first wireless device 121's pathloss and/or data rate to the network, this may be referred to as r1. From the pathloss to the first wireless device 121 the second wireless device 122 can estimate the data rate to/from the first device, this may be referred to as r2. The data rate to the network can then, e.g., be estimated as r =min(r1, r2)/2. This means that in this specific example, to determine which candidate that shall act as a relay node, the second wireless device 122 compares the data rate, such as the effective data rate between the second wireless device 122 and:
the network node 110 direct,
the network node 110 via the first wireless device 121,
the network node 110 via the wireless device 123, and
the network node 110 via the wireless device 124.

The effective data rate is the data rate that can be achieved over the two-hop link, i.e., when transmitting via the relay node. Note that here the packet is first transmitted over the first hop, then over the second hop. In this example, it is decided that first wireless device 121 shall act as a relay node since it offers the best data rate.

Action 207

This is an optional action. The second wireless device 122 may send a report to the network node 110. The report comprises a measurement of the second beacon signal, which measurement is performed by the second wireless device 122.

The report to the network node 110 may comprise a pathloss between the second wireless device 122 and the one or more candidates for providing relay assistance.

I.e. in some embodiments, the report to the network node 110 may comprise the pathloss between the second wireless device 122 and the respective candidates for providing relay assistance, for example the first wireless device 121, and the one or more other wireless devices 123, 124.

As mentioned above, in some embodiments, the determination of which wireless device that shall be acting as the relay node is performed by the network node 110. This report may be sent in these embodiments, but it may also be sent in embodiments wherein the determination of which wireless device that shall be acting as the relay node is performed by second wireless device 122.

Action 208

This is an optional action.

As mentioned above, In this example, it was decided that first wireless device 121 shall act as a relay node since it is assumed that it offers the best data rate.

Before configuring a D2D bearer 131 between the first wireless device 121 and the second wireless device 122 is performed, the configuration may be determined by the second wireless device 122 or the network node 110. In the case wherein the network node 110 has determined the configuration the second wireless device 122 may receive from the network node 110, the configuration of the D2D bearer 131 between the first wireless device 121 that will act as relay node, and the second wireless device 122, enabling said communication to be performed via the D2D bearer 131.

Action 209

The second wireless device 122 configures the D2D, bearer between the first wireless device 121 and the second wireless device 122 which originally, as can be seen from the above, is based on the first beacon signal and/or the second beacon signal, enabling said communication to be performed via the D2D bearer 131 wherein the first wireless device 121 acts as a relay node.

The D2D bearer configuration means determining which physical resource blocks the second device 122 should use for data transmission and which physical resource blocks the first device 121 should use for decoding signals that the first device receives on the said physical resource blocks. In other words, the configuration of the D2D bearer means the allocation of physical resources that the second and first devices 121, 122 use for data communication. The configuration also means to associate certain parameters with the allocated physical resources, such as the maximum allowed transmit power that the second device 122 is allowed to use. The configuration of the D2D bearer in terms of physical resources and associated parameters is done by the cellular base station such as the network node 110, using the measurement reports provided by the second wireless device 122 and the first wireless device 121 and employing existing D2D bearer configuration algorithms. The “determination” means deciding which physical resource blocks and parameters should be used, (done by the network node 110), whereas the actual configuration based on the determination is done by the first and second wireless devices 121, 122 themselves.

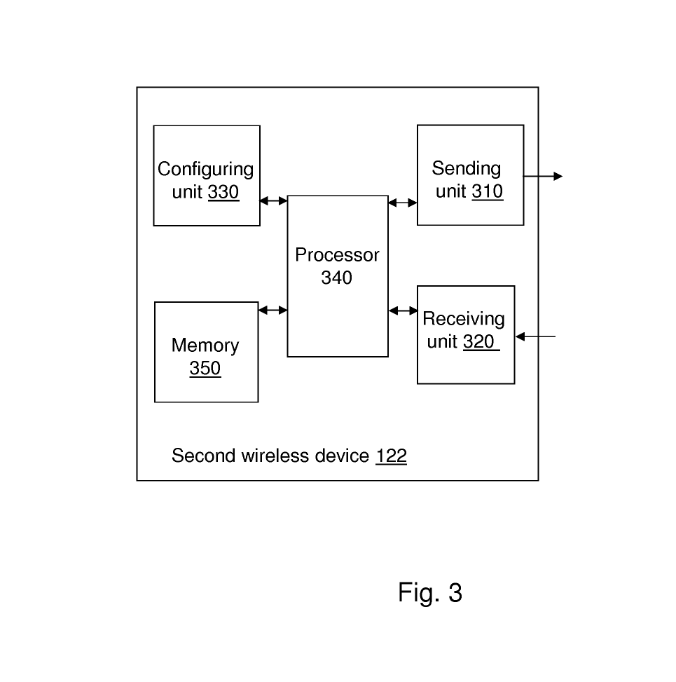

To perform the method actions for for handling relay assistance from the first wireless device 121 in the wireless network 100, described above in relation to FIG. 2, the second wireless device 122 comprises the following arrangement depicted in FIG. 3.

The second wireless device 122 comprises at least one of a sending unit 310 and a receiving unit 320.

The sending unit 310 is adapted to send a first beacon signal to the first wireless device 121. The first beacon signal advertises that the second wireless device 122 needs relay assistance in a radio communication.

The first beacon signal may be adapted to comprise information about any one or more out of: preferred relay types of the second wireless device 122, incentive of assisting the second wireless device 122, type of help needed by the second wireless device 122, position information of the second wireless device 122 , velocity information of the second wireless device 122, UE capability information of the second wireless device 122, group identity of the second wireless device 122, Home operator and/or visited operator of the second wireless device 122.

In some embodiments, the second wireless device 122 is served by the network node 110. The sending unit 310 may further be adapted to send a report to the network node 110. The report comprises a measurement of the second beacon signal. The measurement is performed by the second wireless device 122.

In some embodiments, the sending unit 310 further is adapted to send a report to the network node 110, which report comprises the pathloss between the second wireless device 122 and the candidate for providing relay assistance.

The sending unit 310 may further be adapted to send a report to the network node 110, which report comprises the pathloss between the second wireless device 122 and the respective candidates 121, 123, 124 for providing relay assistance.

The receiving unit 320 is adapted to receive a second beacon signal from the first wireless device 121. The second beacon signal advertises that the first wireless device 121 provides relay assistance in a radio communication in the wireless network 100.

The second beacon signal is adapted to comprise information about any one or more out of: link quality and/or signal strength to serving network node, relaying capability of the first wireless device 121, position information of the first wireless device 121, velocity information of the first wireless device 121, UE capability information of the first wireless device 121, group identity of the first wireless device 121, home operator of the first wireless device 121, visited operator of the first wireless device 121.

The receiving unit 320 may further be adapted to receive from the network node 110, the configuration of the D2D bearer 131 between the first wireless device 121 and the second wireless device 122, enabling said communication to be performed via the D2D bearer 131.

The receiving unit 320 may further be adapted to estimate the pathloss between the second wireless device 122 and the first wireless device 121 on the second beacon signal, and to estimate the pathloss between second wireless device 122 and the network node 110.

The receiving unit 320 may further be adapted to receive one or more further second beacon signals from respective one or more further wireless devices 123,124. The respective one or more further second beacon signals advertises that the respective one or more further wireless devices 123,124 provide relay assistance in the radio communication in the wireless network 100.

In some embodiments the receiving unit 320 further is adapted estimate the pathloss between the second wireless device 122 and the respective one or more further wireless devices 123,124 on the respective second beacons signals.

The second wireless device 122 further comprises a configuring unit 330 adapted to configure a D2D bearer between the first wireless device 121 and the second wireless device 122 based on the first beacon signal and/or the second beacon signal. This enables said communication to be performed via the D2D bearer 131 wherein the first wireless device 121 acts as a relay node.

In some embodiments, the second wireless device 122 is adapted to be served by or is camping on a network node 110. In these embodiments the receiving unit 320 may further be adapted to measure on reference signals from the network node 110, one or more out of a Reference Signal Received Power, RSRP, Reference Signal Received Quality, RSRQ, and Received Signal Strength Indicator, RSSI. In these embodiments, the sending unit 310 may further be adapted to send the first beacon signal when any one of the RSRP, RSSI, and/or RSRQ measurements falls below a threshold.

the second wireless device 122 further comprises a processor 340 adapted to select the first wireless device 121 as a candidate for providing relay assistance, when the estimated pathloss between the second wireless device 122 and the first wireless device 121 is lower compared to the estimated pathloss between the second wireless device 122 and the network node 110.

The processor 340 may further be adapted to determine that the first wireless device being a candidate shall provide relay assistance, if the candidate provides a route, from the second wireless device 122 via the candidate to the network node 110, that has higher data rate than a route from the second wireless device 122 direct to network node 110.

The processor 340 may further be adapted to select any of the respective first wireless device 121 and/or one or more further wireless devices 123,124 as a respective candidate 121, 123, 124 for providing relay assistance, when the estimated pathloss between the second wireless device 122 and any of the respective first wireless device 121 and/or one or more further wireless devices 123,124 are lower compared to the estimated pathloss between the second wireless device 122 and the network node 110.

In some embodiments, the processor 340 further is adapted to determine that the candidate 121, 123, 124 that provides a route with the highest data rate shall provide relay assistance, which route is from the second wireless device 122 via the candidate 121, 123, 124 to the network node 110, if that candidate 121, 123, 124 provides a route that has higher data rate than a route from the second wireless device 122 direct to network node 110.

Embodiments of a Method Seen from the First Device 121 View

Here, embodiments of the method when seen in view of the first wireless device 121, i.e. the helping device will be described. Thus, example of embodiments of a method in the first wireless device 121 for handling relay assistance for the second wireless device 122 in the wireless network 100 will now be described with reference to a flowchart depicted in FIG. 4. In some embodiments, the first wireless device 121 is served by or is camping on a network node 110. The method comprises the following actions, which actions may be taken in any suitable order. Dashed lines of some boxes in FIG. 4 indicate that this action is not mandatory.

Action 401

The first wireless device 121 may measure on reference signals from the network node 110, one or more out of a RSRP, RSRQ, and RSSI.

This is useful since, before advertising that the first wireless device 121 is capable of acting as a relay node for any wireless device in the neighbourhood, or before listening to beacon signals from help needing UEs, the first wireless device 121 may check the quality of its wireless connection to its serving base station such as the network node 110, to see if it is capable of acting as a relay node. If it is, this may trigger advertising by sending of second beacon signals in Action 403 or it may triggering to listen for first beacon signals received in Action 402.

Action 402

For example, D2D Capable UEs such as the first wireless device 121 whose RSRP, RSRQ, and RSSI measurements exceeds a preconfigured threshold and are willing to and capable of providing relaying assistance, may start listening to beacons by UEs such as the second wireless device 122 that advertise their need for relaying assistance.

Therefore, in some embodiments, the first wireless device 121 hears, i.e. receives a first beacon signal from the second wireless device 122. The first beacon signal advertises that the second wireless device 122 needs relay assistance in a radio communication.

The first beacon signal may comprises information about any one or more out of:
preferred relay types of the second wireless device 122,
incentive of assisting the second wireless device 122,
type of help needed by the second wireless device 122,
position information of the second wireless device 122,
velocity information of the second wireless device 122,
UE capability information of the second wireless device 122,
group identity of the second wireless device 122, and
Home operator and/or visited operator of the second wireless device 122.

Action 403

Further, the first device 121 may advertise to D2D capable wireless devices such as the second wireless device 122, in the neighbourhood that it has capability to provide relay help, i.e. relay assistance. In some embodiments, the first wireless device 121 sends a second beacon signal to be received, and decoded by the second wireless device 122. The second beacon signal advertises that the first wireless device 121 has capability to provide relay assistance in a radio communication in the wireless network 100.

As mentioned in Action 401, D2D Capable UEs such as e.g. the first wireless device 121 may regularly measure RSRP and RSSI, and may implicitly also measure RSRQ. In some embodiments, when the RSRP, RSRQ, and RSSI measurements performed in Action 401 exceed a preconfigured threshold, i.e. the radio link to the network node 110 has enough or good quality, these UEs may construct the second beacon signal and start advertising. Therefore the sending of the second beacon signal may be performed when any one of the RSRP, RSSI, and/or RSRQ measurements exceeds a threshold. For example when the measured or estimated uplink path loss from the helper UE, i.e. the first wireless device 121 to the serving base station, such as the network node 110, is less than 120 dB, the first wireless device 121 can declare itself as a potential helper capable wireless device. This threshold value in general depends on other components of the wireless device's uplink link budget, transmit power headroom and other factors generally well known for the person skilled in the art. The second beacon signal may comprise information about any one or more out of:

Link quality and/or signal strength to serving network node, such as the quality of the radio link they currently have to their serving Base Station (BS) such as the network node 110 in connected mode or the BS they are currently camping on in idle mode. This information may be encoded into e.g. 8 levels, 3 bits.
Relaying capability of the first wireless device 121, The relaying capability they may provide such as e.g. any of AF, LF, DF, CF, EF or GF, see definitions in the end of the description. This information may be encoded into e.g. 4 bits.;
Position information of the first wireless device 121, if available. The position information may be based on 3GPP or GPS technology and coordinates.
Velocity information of the first wireless device 121, if available.
Other UE capability information of the first wireless device 121, such as e.g. available Radio Access Technologies (RATs) for example LTE, HSPA, and Wireless Local Area network (WLAN).
Estimated downlink and uplink data rates from and/or to the access point.
Group identity of whom it the first wireless device 121 is willing to provide relay assistance such as for example all UEs, UEs belonging to a Specific Buddy List, or only non-roaming UEs, i.e. UEs served by the Home Operator.
Home operator of the first wireless device 121.
Visited operator of the first wireless device 121.
D2D capability
incentive it requires

The duty cycle of the second beacon signal may be determined by the network such as e.g. the network node 110 or be autonomously adjusted by the first wireless device 121 based on, e.g. its battery status.

The first wireless device 121 may also send a registration message to a BS such as the network node 110, in connected mode, or to a MME in a TA in idle mode with similar content as in the second beacon signal described above.

Action 404

In some embodiments the first wireless device 121 is served by the network node 110. In these embodiments the first wireless device 121 may send a report to the network node 110, which report comprises a measurement of the first beacon signal such as a pathloss measurement, which measurement is performed by the first wireless device 121. This may be used by the network node 110 to decide if the first wireless device shall act as relay node. This measurement as performed by the first wireless device 121 and reported to the network node 110, allows the network node 110 to estimate the link quality between the second wireless device 122 and the first wireless device 121 and thereby determine if the first wireless device 121 can provide relaying assistance to the second wireless device 122. For example, if the radio link between the second wireless device 122 and first wireless device 121 is too weak, then the first wireless device 121 cannot decode the signals sent by the second wireless device 122 and thereby the first wireless device 121 cannot act as a helper device.

Action 405

The first wireless device 121 may receive from a network node 110 in the wireless network 100, the configuration of the D2D bearer 131 between the first wireless device 121 and the second wireless device 122 , enabling said communication to be performed via the D2D bearer 131

Action 406

The first wireless device 121 configures the D2D bearer 131 between the first wireless device 121 and the second wireless device 122 based on the first beacon signal and/or the second beacon signal, enabling said radio communication to be performed via the D2D bearer 131 wherein the first wireless device 121 acts as a relay node.

The first wireless device 121 may have sent the second beacon signal and received an answer to the second beacon signal from the second device 122, that the second wireless device 122 need relay assistance from the first wireless device 121. As an alternative or as combined, the first wireless device 121 may have heard the first beacon signal from the second wireless device 122. In these ways the first wireless device 121 may have identified that the second wireless device 122, need relay assistance from the first wireless device 121. It may therefore configure the D2D bearer 131 between the first wireless device 121 and the second wireless device 122 based on this and by the received configuration from the network node 110 in Action 405.

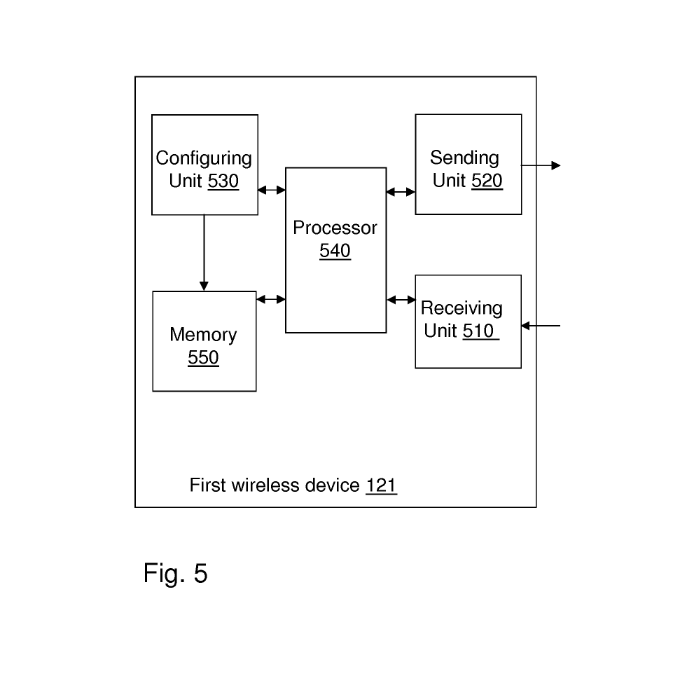

To perform the method actions for handling relay assistance for a second wireless device 122 in a wireless network 100 described above in relation to FIG. 4, first wireless device 121, comprises the following arrangement depicted in FIG. 5.

The first wireless device 121 comprising at least one of a receiving unit 510 and a sending unit 520.

The receiving unit 510 is adapted to receive a first beacon signal from the second wireless device 122. The first beacon signal advertises that the second wireless device 122 needs relay assistance in a radio communication.

The first beacon signal may comprise information about any one or more out of: preferred relay types of the second wireless device 122, incentive of assisting the second wireless device 122, type of help needed by the second wireless device 122, position information of the second wireless device 122, velocity information of the second wireless device 122, UE capability information of the second wireless device 122, group identity of the second wireless device 122, Home operator and/or visited operator of the second wireless device 122.

The receiving unit 510 may further be adapted to receive from a network node 110 in the wireless network 100, the configuration of the D2D bearer 131 between the first wireless device 121 and the second wireless device 122, enabling said communication to be performed via the D2D bearer 131.

In some embodiments, the first wireless device 121 is served by or is camping on the network node 110. In these embodiments, the receiving unit 510 may further be adapted to measure on reference signals from the network node 110, one or more out of a Reference Signal Received Power, RSRP, Reference Signal Received Quality, RSRQ, and Received Signal Strength Indicator, RSSI.

The sending unit 520 is adapted to send a second beacon signal to be received by the second wireless device 122. The second beacon signal advertises that the first wireless device 121 has capability to provide relay assistance in a radio communication in the wireless network 100.

The second beacon signal may comprise information about any one or more out of: link quality and/or signal strength to serving network node, relaying capability of the first wireless device 121, position information of the first wireless device 121, velocity information of the first wireless device 121, UE capability information of the first wireless device 121, group identity of whom the first wireless device 121 is willing to provide relay assistance, home operator of the first wireless device 121, visited operator of the first wireless device 121.

In some embodiments, the first wireless device 121 is served by the network node 110. In these embodiments, the sending unit 520 may further be adapted to send a report to the network node 110. The report comprises a measurement of the first beacon signal, which measurement is performed by the first wireless device 121.

The sending unit 520 may further be adapted to send the second beacon signal when any one of the RSRP, RSSI, and/or RSRQ measurements falls below a threshold.

The first wireless device 121 further comprises a configuring unit 530 adapted to configure a D2D bearer 131 between the first wireless device 121 and the second wireless device 122 based on the first beacon signal and/or the second beacon signal. This enables said radio communication to be performed via the D2D bearer 131 wherein the first wireless device 121 acts as a relay node.

Embodiments of a method seen from the network node 110 view

Here, embodiments of the method when seen from the network node 121 view will be described. Thus, example of embodiments of a method in a network node 110 for handling relay assistance by a first wireless device 121 to a second wireless device 122 in a wireless network 100 will now be described with reference to a flowchart depicted in

FIG. 6. The second wireless device 122 needs relay assistance in a radio communication. The method comprises the following actions, which actions may be taken in any suitable order. Dashed lines of some boxes in FIG. 6 indicate that this action is not mandatory.

Action 601

This is an optional action. As mentioned above, the beacon signal may comprise a first beacon signal and/or a second beacon signal.

As further mentioned above, in addition, the network (NW) such as e.g. the network node 110, may assist the matching process according to the following:
The NW may allocate specific resources such as e.g. SubFrames (SF) and Physical resource Blocks (PRBs) for such beacon signaling such as e.g. the emergency signal channel. The emergency signal channel may be broadcast by an eNB such as the network node 110, or it may be transmitted to the UE such as the first and/or second wireless device 121, 122 as part of a registration procedure.
The knowledge of such channels, specific SF and PRB positions, allows for fast discovery and low duty cycle ,=low energy consumption, of beacons, since the UEs know which SF and PRBs they should use for beacon transmission, while the potential helper UEs know which SF and PRB they should listen to and decode to capture such beacons by UEs requesting relaying service.

D2D Capable UEs who are in or close to outage situation, listen to beacons by UEs in favorable conditions. Also, for such UEs the same logic on low duty cycle as above applies.

Therefore, in some embodiments the network node 110 allocates a channel for the first beacon signal to be sent by the second wireless device 122. The first beacon signal advertises that the second wireless device 122 requires relay assistance in a radio communication.

In some embodiments, the network node 110 further or alone allocates a channel for the second beacon signal to be sent by the first wireless device 121. The second beacon signal advertises that the first wireless device 121 is capable of providing relay assistance in a radio communication in the wireless network 100.

The duty cycle of the beacon signal may be determined by the network such as e.g. the network node 110 or be autonomously adjusted by the first and/or second wireless device 121, 122 based on, e.g., the battery status.

Action 602

During a NW assisted matching step, both types of UEs, i.e. the first wireless device 121 and the second wireless device 122 may perform measurements on the received beacon signals. If the beacon measurements indicate risk of failure such as e.g. low path loss, the beacon receiving UE sends back a page signal to the beacon signalling UE and optionally also to the BS such as the network node 110.

The BS such as the network node 110 may perform matching and Mode Selection (MS) i.e. whether wireless devices in the proximity of each other should communicate via a direct link or through a cellular base station or access point, for the UEs, based on:
measurement report between the two UEs, i.e. the first wireless device 121 and the second wireless device 122.
UE capabilities such as supported frequency bands, maximum transmit power relaying capabilities, and/or duplexing capabilities.

The matching step performed by the BS such as the network node 110 is similar to the mode selection step in traditional cellular network assisted D2D communications, but according to embodiments herein it also involves the checking of the type of relaying service requested and the type of relaying service offered.

Therefore the network node 110 may receive one or more reports from the first wireless device 121 and/or the second wireless device 122. The one or more reports comprise a respective measurement of a beacon signal sent between the first wireless device and the second wireless device.

For example, the network node 110 may receive from the second wireless device 122, a report comprising the pathloss between the second wireless device 122 and the first wireless device 121 being a candidate for providing relay assistance.

Further, the network node 110 may receive from the one or more further wireless devices 123,124, a respective report comprising the pathloss between the second wireless device 122 and respective further wireless devices 123,124 also being candidates 123, 124 for providing relay assistance.

Action 603

Based on the reported pathloss, the network node 110 may determine that the first wireless device 121 being a candidate shall provide relay assistance, if the candidate provides a route, from the second wireless device 122 via the candidate to the network node 110, that has higher data rate than a route from the second wireless device 122 direct to network node 110.

Based on the reported pathloss, the network node 110 may determine that the candidate 121, 123, 124 that provides a route with the highest data rate shall provide relay assistance, which route is from the second wireless device 122 via the candidate 121, 123, 124 to the network node 110 if that candidate 121, 123, 124 provides a route that has higher data rate than a route from the second wireless device 122 direct to network node 110, based on the reported pathloss.

As mentioned above, In this example, it is decided that the first wireless device 121 shall act as a relay node since it is assumed to offer the best data rate.

Action 604

If the beacon measurement report indicates sufficiently strong D2D link, and it is indicates that the UEs such as the first wireless device 121 and the second wireless device 122 relaying capabilities match, then the BS such as the network node 110 decides on D2D bearer establishment. Such bearer establishment may involve a number of relaying service specific parameters, such as e.g. any one of:
reserving resources for the D2D link for some period, e.g., a couple of 100 ms;
notifying UEs such as the first wireless device 121 and the second wireless device 122 about bearer establishment;
sending configuration parameters to both the helping UE such as the first wireless device 121 and to the relay needing UE such as the second wireless device 122.

The UEs such as the first wireless device 121 and the second wireless device 122 may continue to periodically measure and report on the quality of the D2D link to the BS so that the BS can execute MS on a periodic or event triggered basis.

Therefore when the measurement in the one or more reports exceeds the threshold, the network node 110 sends to the first wireless device 121 and the second wireless device 122, a configuration of a D2D bearer 131 between the first wireless device 121 and the second wireless device 122. This enables said communication to be performed via the D2D bearer 131 wherein the first wireless device 121 acts as a relay node.

The configuration of the D2D bearer 131 between the first wireless device 121 and the second wireless device 122 may involve one or more out of: reserving resources for the D2D link for a time period, notifying the first wireless device 121 and the second wireless device 122 about bearer 131 establishment, and/or sending configuration parameters to the first wireless device 121 and the second wireless device 122.

To perform the method actions for handling relay assistance by a first wireless device 121 to a second wireless device 122 in a wireless network 100 described above in relation to FIG. 6, network node 110 comprises the following arrangement depicted in FIG. 7.

The network node 110 comprises a receiving unit 710 adapted to receive one or more reports from the first wireless device 121 and/or the second wireless device 122. The one or more reports comprise a respective measurement of a beacon signal sent between the first wireless device 121 and the second wireless device 122.

In some embodiments, the receiving unit 710 further is adapted to receive from the second wireless device 122, a report comprising the pathloss between the second wireless device 122 and the first wireless device 121 being a candidate for providing relay assistance.

The receiving unit 710 may further be adapted to receive from the one or more further wireless devices 123,124, a respective report comprising the pathloss between the second wireless device 122 and respective further wireless devices 123,124 also being candidates 123, 124 for providing relay assistance.

The network node 110 further comprises a sending unit 720 adapted to, when the measurement in the one or more reports exceeds a threshold, send to the first wireless device 121 and the second wireless device 122, a configuration of a D2D bearer 131 between the first wireless device 121 and the second wireless device 122. This enables said communication to be performed via the D2D bearer 131 wherein the first wireless device 121 acts as a relay node.

The configuration of the D2D bearer 131 between the first wireless device 121 and the second wireless device 122 may be adapted to involve one or more out of: reserving resources for the D2D link for a time period, notifying the first wireless device 121 and the second wireless device 122 about bearer 131 establishment, and/or sending configuration parameters to the first wireless device 121 and the second wireless device 122.

The network node 110 may further comprise a processor 730. The measurement in the one or more reports exceeding a threshold may be established by the processor 730.

The processor 730, may be adapted to, based on the reported pathloss, determine that the first wireless device 121 being a candidate shall provide relay assistance, if the candidate provides a route, from the second wireless device 122 via the candidate to the network node 110, that has higher data rate than a route from the second wireless device 122 direct to network node 110.

In some embodiments, the processor 730, may further be adapted to determine that the candidate 121, 123, 124 that provides a route with the highest data rate shall provide relay assistance, which route is from the second wireless device 122 via the candidate 121, 123, 124 to the network node 110 if that candidate 121, 123, 124 provides a route that has higher data rate than a route from the second wireless device 122 direct to network node 110, based on the reported pathloss.

The network node 110 may further comprise an allocating unit 740 adapted to allocate a channel for the first beacon signal to be sent by the second wireless device 122. The first beacon signal advertises that the second wireless device 122 requires relay assistance in a radio communication.

In some embodiments the allocating unit 740 is further adapted to allocate a channel for the second beacon signal to be sent by the first wireless device 121. The second beacon signal advertises that the first wireless device 121 is capable of providing relay assistance in a radio communication in the wireless network 100.

The embodiments herein for handling relay assistance may be implemented through one or more processors, such as a respective processor such as a processor 340 in the second wireless device 122 depicted in FIG. 3, a processor 540 in the first wireless device 121 depicted in FIG. 5, and/or a processor 730 in the network node 110 depicted in FIG. 7, together with computer program code for performing the functions and actions of the embodiments herein. The program code mentioned above may also be provided as a computer program product, for instance in the form of a data carrier carrying computer program code for performing the embodiments herein when being loaded into the in the first wireless device 121, the second wireless device and/or the network node 110. One such carrier may be in the form of a CD ROM disc. It is however feasible with other data carriers such as a memory stick. The computer program code may furthermore be provided as pure program code on a server and downloaded to the first wireless device 121, the second wireless device and/or the network node 110.

The first wireless device 121, the second wireless device and/or the network node 110 may further comprise a respective memory, such as a memory 350 in the second wireless device 122 depicted in FIG. 3, a memory 550 in the first wireless device 121 depicted in FIG. 5, and/or a memory 750 in the network node 110 depicted in FIG. 7, comprising one or more memory units. The respective memory is arranged to be used to store information about which channel to use for beacon signaling, beacon response, measurements, and/or data communication. Further to store, configurations, schedulings, and applications to perform the methods herein when being executed in the respective the first wireless device 121, the second wireless device and/or the network node 110.

Those skilled in the art will also appreciate that the respective sending unit, the receiving unit, the allocating unit, the configuring unit described above may refer to a combination of analog and digital circuits, and/or one or more processors configured with software and/or firmware, e.g. stored in the memory, that when executed by the one or more processors perform as described above. One or more of these processors, as well as the other digital hardware, may be included in a single Application-Specific Integrated Circuitry (ASIC), or several processors and various digital hardware may be distributed among several separate components, whether individually packaged or assembled into a System-on-a-Chip (SoC).

The text below refers to any embodiment mentioned above.

Advertising

According to embodiments herein, both types of UEs i.e. potential helpers such as the first wireless device 121, and UEs that need assistance such as the second wireless device may construct and broadcast beacons signals. According to some embodiments herein, a given UE at one point in time may only be broadcasting one out of the types of beacons i.e. in some embodiments, a UE may only declare itself as potential helper such as the first wireless device 121, or in need of help such as the second wireless device 122.

The NW such as the network node 110 may allocate specific resources such as e.g. subframes (SF) and PRBs for such beacon signaling, e.g. the “SOS” channel, i.e. the emergency signal. The SOS channel may be broadcast by the eNB such as the network node 110, or it may be transmitted to the UE as part of the registration procedure

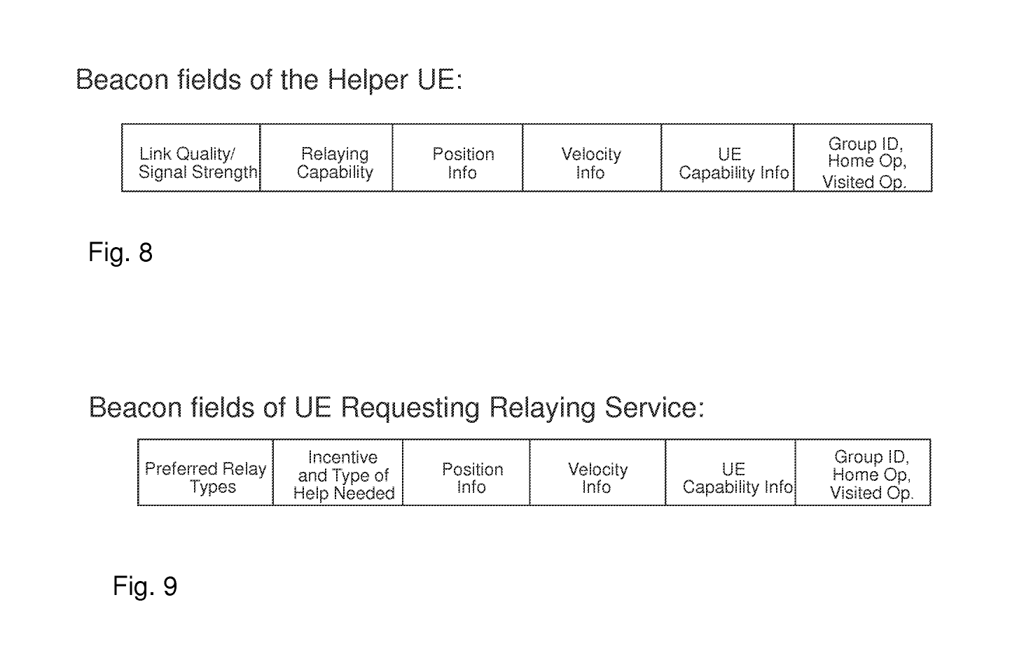

FIG. 8 depicts an example of Beacon signalling fields of a of the helper UE such as the first wireless device 121. The beacon fields of the of the second beacon signal sent by the first wireless device 121, i.e. the helper UE may comprise information about any one or more out of: Link quality/signal strength, relaying capability, position information, velocity information, UE capability information, group identity, Home operator, visited operator. There may further be a field (not shown) in the beacon signal comprising a System Frame Number (SFN) number and a Physical Resource Block (PRB) number that specifies which resources the wireless devices use to transmit and listen to for the transmission and capturing of the distress signal, i.e. the “Help Request” signal.

FIG. 9 discloses an example of Beacon signalling fields of the UE that requests a relaying help from UEs in its vicinity, such as the second wireless device 122. The Beacon fields of the first beacon signal send t by the second wireless device 122, i.e. the UE requesting help may comprise information about any one or more out of: Preferred relay types, incentive and type of help needed, position information, velocity information, UE capability information, group identity, Home operator, visited operator.

Also here, it may further be a field (not shown) in the beacon signal comprising a SFN number and a PRB number that specifies which resources the wireless devices use to transmit and listen to for the transmission and capturing of the distress signal, i.e. the “Help Request” signal.

Example to Illustrate embodiments Herein

A schematic example of embodiments herein is given to illustrate the methods explained above. In the example there is a mobile user, the second wireless device 122 (wd122) communicating with the base station, eNB such as e.g. the network node 110 (nn110). In a cell covered by the network node 110 there are also three additional wireless devices, the first wireless device 121 (wd121), and the other wireless devices 123, 124 (wd123), (wd124) out of which the first wireless device 121 and the wireless device 123 are decode-and-forward relaying capable and willing to help other wireless devices, while the wireless device 124 is not a potential helper and therefore does not participate. The concept of decode and forward relaying is described in the end of the description. As the second wireless device 122 is located out on the cell border and has a relatively poor channel to the network node 110 it might benefit from assistance from other wireless devices.

The pathloss between the network node 110 and the wireless devices are as follows:

nn110−d122: 137 dB

nn110−wd121: 130 dB

nn110−d123: 124 dB

Advertising

The second wireless device 122, which is in need of assistance, broadcasts a beacon signal where it declares itself in need of help. The first wireless device 121 and the wireless device 123 have declared themselves as potential helpers and make this information available to other wireless devices via their beacon signals. The beacon signals also comprises other information as described in above e.g., the UEs' D2D capabilities. From RSRP measurements on the beacons signal(s) it is possible for a UE to estimate the pathloss between itself and other UEs. In this example we have the following pathloss relations between the second wireless device 122 and the two potential helpers:

wd122−wd121: 122 dB

wd122−wd123: 138 dB

NW Assisted Matching

The matching may be performed in many different ways and may reside either in the network node 110, in the wireless devices such as the second wireless device 122, or in both. Here it is assumed that the second wireless device 122 performs an initial selection and then lets the network node 110 take the final matching decision. As the pathloss between the network node 110 and the second wireless device 122 is lower compared to the pathloss between the second wireless device 122 and the wireless device 123, it is not likely that the wireless device 123 can improve the communication between the second wireless device 122 and the network node 110. Hence, the second wireless device 122 removes the wireless device 123 from the candidate list. The first wireless device 121 is still considered as a potential helper and the pathloss between the second wireless device 122 and first wireless device 121 is reported to the network node 110.

The network node 110 is now aware of the pathloss relationships between the network node 110 and respective second wireless device 122 and first wireless device 121, as well as in between the two wireless devices, the first wireless device 121 and the second wireless device 122. The link rate decreases with the pathloss. To explain in a simple way, the signal-to-noise ratios (SNR)=Ptx−L−N, where Ptx is the transmission power, L is the pathloss and N is the noise. The link rate is then a function of the SNR and the bandwidth. Theoretically, the link rate=bw*log2(1+SNR). From the pathloss relationships the network node 110 may estimate the following link rates.

wd122−nn110: 0.3 Mbps

wd122−wd121: 3.1 Mbps

wd121−nn110: 1.5 Mbps

In the next step the network node 110 estimates the effective data rates between the second wireless device 122 and the network node 110 via the different candidate routes. In this example there are two possible routes, either directly from the second wireless device 122 to the network node 110 or via the first wireless device 121, i.e., first from the second wireless device 122 to the first wireless device 121 and then from the first wireless device 121 to the network node 110. When a helping decode-and-forward wireless device is involved as a relay node, it is in this example assumed that the transmission uses two slots instead of one and that the rate is limited by the link with the lowest throughput. It is first needed to transmit the data to the relay node (slot 1), then from the relay node to the network (slot 2).

wd122−nn110: 0.3 Mbps

wd122−wd121−n110: min(3.1, 1.5)/2 Mbps=0.75 Mbps,

wherein min means minimum, i.e. lowest, and Mbps means megabits per second.

Based on this the network node determines that it should set up the transmission via the helper wireless device, i.e. the first wireless device 121.

D2D Bearer Configuration and Establishment

As described above, the network node 110 may configure and establish the D2D bearer.

Advantages of embodiments herein is that the problems described in the beginning of the detailed description may be solved and thereby D2D communication may be used to increase the cooperation between UEs such as the first wireless device 121 and the second wireless device 122, served by a cellular network. Specifically, the following advantages over prior art techniques are emphasized:
UEs such as the first wireless device 121 willing to and capable of providing relaying service to other UEs such as the second wireless device 122 may actively indicate their capability and willingness and can take advantage of network such as the network node 110 assistance in their search process;
UEs such as the second wireless device 122, that are in need of relaying assistance may actively indicate what kind of relaying services they need by a low duty cycle beaconing mechanism and can capture the beacon signals of relaying capable other UEs such as the first wireless device 121;
By means of the proposed mechanism the network node 110 may help cell edge UEs and relaying capable UEs such as the first wireless device 121 and the second wireless device 122, to find one another and set up a D2D communication link.

All in all, the advantage of the embodiments herein is that it takes advantage of network assisted D2D communications to improve the performance of the cellular network by exploiting the capabilities of UEs such as the first wireless device 121 and the second wireless device 122, currently present in the system. Thus, operators may reduce the deployment costs associated with installing and maintaining repeater and various kinds of relaying infrastructure.

According to some embodiments,
UE node such as the first wireless device 121 and the second wireless device 122 performing beaconing according to the proposed scheme;
NW node such as the network node 110 performing mode selection taking into account relaying capability information;
NW node such as the network node 110 configuring the D2D bearer such that relaying is configured dynamically according to available helper UEs and UEs that are in need of relaying service.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

### ABBREVIATIONS

AF Amplify and Forward
CF Compress and Forward
CMAS Commercial Mobile Alert System
CR Cooperative Relaying
D2D Device-to-Device
DF Decode and Forward
EF Estimate and Forward
E-SMLC Evolved Serving Mobile Location Server
EWS Earthquake and Tsunami Warning System
GF Gather and Forward
GNSS Global Navigation Satellite System
GPS Global Positioning System
GMLC Gateway Mobile Location Center
LCS Location Services
LF Linear-Process and Forward
LTE Long Term Evolution
LPP LTE Positioning Protocol
MME Mobility Management Entity
nLF Nonlinear-Process and Forward
MSISDN Mobile Station International Subscriber Directory Number
NEW Network Entity
OFDM Orthogonal Frequency Division Multiplexing
OTDOA Observed Time Difference of Arrival
PDF Peer Discovery Frame
PDR Peer Discovery Resource
PF Purge and Forward
PLMN Public Land Mobile Network (PLMN)
PRB Physical Resource Block
PWS Public Warning System
PSS Primary Synchronization Signal
RAT Radio Access Technology
SR Supportive Relaying
RLF Radio Link Failure
RSRP Reference Signal Received Power
RSRQ Reference Signal Received Quality
RSSI Received Signal Strength Indicator
SSS Secondary Synchronization Signal
TA Tracking Area
UTDOA Uplink Time Difference of Arrival

Type of Relays and Associated Parameters Supported by the Embodiments Herein.

Amplify and Forward (AF)

The signal received by AF relays is amplified, frequency translated and retransmitted.

Parameters: amplification factor, frequency translation information (e.g. frequency channels for the output signal)

Linear Process and Forward (LF)

LF relays perform some simple linear operation, typically in the analogue domain, on the signal before retransmission. For example, it may be phase shifting that facilitates the implementation of distributed beam forming.

Non Linear Process and Forward (nLF)

nLF relays perform some non-linear operation on the signal prior to retransmission. An example may be a nonlinear amplification of a signal that can be useful to reduce the end-to-end error rate.

Estimate and Forward (EF)

EF relays estimate the originally transmitted signal, in the baseband, after which the EF relay retransmits the estimate possibly by using a different modulation and coding scheme. Thus, the retransmitted signal may be transmitted by an optimal modulation for the relay-BS link.

Compress and Forward (CF)

CF relays are similar to EF relays, but CF relays can also involve some source coding technique to compress the original data stream. This may be especially useful when the compressing relay, i.e. the helper UE, is close to the BS and has favorable link quality. In which case it may, for example remove some redundancy from the original data stream without increasing the residual block error rates.

Decode and Forward (DF)

DF relays detects the signal, decodes it and re-encodes it prior to retransmission. DF is known to be performance optimal with respect to e.g. end-to-end error rate.

Purge and Forward (PF)

PF relays employ sophisticated interference cancellation methods to cancel as much as possible of the interference present at the receiver relay. PF may be used in combination of some other relaying techniques, such as DF.

Gather and Forward (GF)

GF is sometimes also referred to as “Aggregate and Forward” and may be seen as an extension of the CF relaying protocol. GF may apply source coding over a large number of communication slots rather than performing source coding on the sampled information as CF does.

Parameters Associated with Regenerative Relaying Protocols

Choice of and Associated Parameters of Channel Code

Channel codes applicable for the relay-BS link include “no channel coding”, block codes, trellis codes and the concatenations thereof. For example, trellis codes may correct with a given probability a given density of errors, e.g. an error in every 10 bits in average corrected with probability 90%. Trellis codes are a special family of convolutional codes originally applied in the context of digital communications over telephone lines (modems). Space-time trellis codes are applicable in relay assisted cellular communications as it is known for the skilled in the art person.

Choice of Interleaver

The interleaver rearranges the output bit stream with regard to input bit stream with the purpose of breaking of long sequences of errors, so called error bursts. This can be useful in block fading environments, but needs memory at the interleaver node in order to achieve long interleaving distances.

Choice of Waveform and Modulation

The choice of waveform and modulation involves determining whether the transmission should be single versus multicarrier, as for example in LTE UL or DL respectively. The choice of modulation may comprise a large number of parameters, for example related to coherent or differential modulation schemes. For example, in general coherent modulation outperforms differential modulation at the expense of accurate Channel State Information at the Receiver (CSIR). Differential modulation is more suitable in environments where the channel varies rapidly, in the case of the embodiments herein between the helper UE and BS).

Choice of Space-Time Processing

If the relay node, helper wireless device, such as the first wireless device 121, has multiple antennas, then a large number of different space-time of space-frequency coding may be available at the helper UE, depending on the capabilities of the helper UE and the eNB such as the network node 110. Typically, these codes work well in rich scattered channels in order to use the full potential of the Multiple In Multiple Out (MIMO) channel.

Power Control

Both regenerative relays and simpler relays may use different (adaptive or non-adaptive) amplification factors to manage Signal-to-Noise Ratio (SNR) and Signal-to-Interference plus Noise-Ratio (SINR) at the receiver, in the eNB such as the network node 110.

Choice of Receiver

The choice of the receiver technique applied by the helper UE such as the first wireless device 121, depending on UE capabilities and possible some control parameters, may have a large impact on the received SINR and BLock Error Rate (BLER). These receiver techniques, e.g. Zero Forcing (ZF), Minimum Mean Square Error (MMSE), typically trade off performance with complexity, channel estimation requirements that mat be suitable indifferent fading environments.

1-44. (canceled)

45. A method in a second wireless device for handling relay assistance from a first wireless device in a wireless network, the method comprising:
at least one of:
sending a first beacon signal to the first wireless device, which first beacon signal advertises that the second wireless device needs relay assistance in a radio communication; and
receiving a second beacon signal from the first wireless device, which second beacon signal advertises that the first wireless device provides relay assistance in a radio communication in the wireless network; and
wherein the method further comprises configuring a Device to Device (D2D) bearer between the first wireless device and the second wireless device based on the first beacon signal and/or the second beacon signal, thereby enabling said radio communication to be performed via the D2D bearer and wherein the first wireless device acts as a relay node.

46. The method according to claim 45, wherein the second wireless device is served by a network node and method further comprises sending a report to the network node, which report comprises a measurement of the second beacon signal, which measurement is performed by the second wireless device.

47. The method according to claim 45, further comprising receiving from the network node, the configuration of the D2D bearer between the first wireless device and the second wireless device, enabling said communication to be performed via the D2D bearer.

48. The method according to claim 45, wherein the second wireless device is served by or is camping on a network node, and wherein the method further comprises:
measuring on reference signals from the network node, one or more out of a Reference Signal Received Power (RSRP), Reference Signal Received Quality (RSRQ), and Received Signal Strength Indicator (RSSI); and
wherein the sending of the first beacon signal is performed when any one of the RSRP, RSSI, and/or RSRQ measurements falls below a threshold.

49. The method according to claim 45, wherein the first beacon signal comprises information about any one or more out of: preferred relay types of the second wireless device, incentive of assisting the second wireless device, type of help needed by the second wireless device, position information of the second wireless device, velocity information of the second wireless device, UE capability information of the second wireless device, group identity of the second wireless device, Home operator and/or visited operator of the second wireless device.

50. The method according to claim 45, wherein the second beacon signal comprises information about any one or more out of: link quality and/or signal strength to serving network node, relaying capability of the first wireless device, position information of the first wireless device, velocity information of the first wireless device, UE capability information of the first wireless device, group identity of the first wireless device, home operator of the first wireless device, visited operator of the first wireless device.

51. The method according to claim 45, the method further comprising:
estimating the pathloss between the second wireless device and the first wireless device on the second beacons signal;
estimating the pathloss between second wireless device and the network node;
when the estimated pathloss between the second wireless device and the first wireless device is lower compared to the estimated pathloss between the second wireless device and the network node, selecting the first wireless device as a candidate for providing relay assistance.

52. The method according to claim 51, the method further comprising:
determining that the first wireless device being a candidate shall provide relay assistance, if the candidate provides a route, from the second wireless device via the candidate to the network node, that has higher data rate than a route from the second wireless device direct to network node; and/or
wherein the sending a report to the network node comprises reporting to the network node the pathloss between the second wireless device and the candidate for providing relay assistance.

53. The method according to claim 45, wherein the receiving a second beacon signal from the first wireless device further comprises receiving one or more further second beacon signals from respective one or more further wireless devices, which respective one or more further second beacon signals advertise that the respective one or more further wireless devices provide relay assistance in the radio communication in the wireless network.

54. The method according to claim 53, the method further comprising:
wherein the estimating further comprises estimating the pathloss between the second wireless device and the respective one or more further wireless devices on the respective second beacons signals; and
wherein, when the estimated pathloss between the second wireless device and any of the respective first wireless device and/or one or more further wireless devices is lower compared to the estimated pathloss between the second wireless device and the network node, selecting these any of the respective first wireless device and/or one or more further wireless devices as a respective candidate for providing relay assistance.

55. The method according to claim 54, the method further comprising:
wherein the determining comprises determining that the candidate that provides a route with the highest data rate shall provide relay assistance, which route is from the second wireless device via the candidate to the network node if that candidate provides a route that has higher data rate than a route from the second wireless device direct to network node; and/or
wherein the sending a report to the network node comprises reporting to the network node the pathloss between the second wireless device and the respective candidates for providing relay assistance.

56. A method in a network node for handling relay assistance by a first wireless device to a second wireless device in a wireless network, which second wireless device needs relay assistance in a radio communication, the method comprising:
receiving one or more reports from the first wireless device and/or the second wireless device, which one or more reports comprise a respective measurement of a beacon signal sent between the first wireless device and the second wireless device; and
when the measurement in the one or more reports exceeds a threshold, sending to the first wireless device and the second wireless device, a configuration of a Device to Device (D2D) bearer between the first wireless device and the second wireless device, thereby enabling said radio communication to be performed via the D2D bearer, wherein the first wireless device acts as a relay node.

57. The method according to claim 56, the method further comprising:
wherein the receiving one or more reports comprises receiving from the second wireless device, a report comprising the pathloss between the second wireless device and the first wireless device being a candidate for providing relay assistance; and
wherein the measurement in the one or more reports exceeding a threshold is established by, based on the reported pathloss, determining that the first wireless device being a candidate shall provide relay assistance, if the candidate provides a route, from the second wireless device via the candidate to the network node, that has higher data rate than a route from the second wireless device direct to network node.

58. The method according to claim 57, further comprising:
wherein the receiving one or more reports further comprises receiving from the one or more further wireless devices, a respective report comprising the pathloss between the second wireless device and respective further wireless devices also being candidates for providing relay assistance; and
wherein the measurement in the one or more reports exceeding a threshold is established by, based on the reported pathloss, determining that the candidate that provides a route with the highest data rate shall provide relay assistance, which route is from the second wireless device via the candidate to the network node if that candidate provides a route that has higher data rate than a route from the second wireless device direct to network node, based on the reported pathloss.

59. The method according to claim 56, wherein the beacon signal comprises a first beacon signal and/or a second beacon signal the method further comprising:
allocating a channel for the first beacon signal to be sent by the second wireless device, which first beacon signal advertises that the second wireless device requires relay assistance in a radio communication; and/or
allocating a channel for the second beacon signal to be sent by the first wireless device, which second beacon signal advertises that the first wireless device is capable of providing relay assistance in a radio communication in the wireless network.

60. The method according to claim 56, wherein the configuration of the D2D bearer between the first wireless device and the second wireless device involves one or more out of: reserving resources for the D2D link for a time period, notifying the first wireless device and the second wireless device about bearer establishment, and/or sending configuration parameters to the first wireless device and the second wireless device.

61. A method in a first wireless device for handling relay assistance for a second wireless device in a wireless network, the method comprising:
at least one of:
receiving a first beacon signal from the second wireless device, which first beacon signal advertises that the second wireless device needs relay assistance in a radio communication; and
sending a second beacon signal to be received by the second wireless device, which second beacon signal advertises that the first wireless device has capability to provide relay assistance in a radio communication in the wireless network; and
wherein the method further comprises configuring a Device to Device (D2D) bearer between the first wireless device and the second wireless device based on the first beacon signal and/or the second beacon signal, thereby enabling said radio communication to be performed via the D2D bearer, wherein the first wireless device acts as a relay node.

62. The method according to claim 61, wherein the first wireless device is served by a network node and the method further comprises sending a report to the network node, which report comprises a measurement of the first beacon signal, and which measurement is performed by the first wireless device.

63. The method according to claim 61, further comprising receiving from a network node in the wireless network, the configuration of the D2D bearer between the first wireless device and the second wireless device, for enabling said radio communication to be performed via the D2D bearer.

64. The method according to claim 61, wherein the first wireless device is served by or is camping on a network node, and wherein the method further comprises measuring on reference signals from the network node, one or more out of a Reference Signal Received Power (RSRP), Reference Signal Received Quality (RSRQ), and Received Signal Strength Indicator (RSSI), and wherein the sending of the second beacon signal is performed when any one of the RSRP, RSSI, and/or RSRQ measurements exceeds a threshold.

65. The method according to claim 61, wherein the first beacon signal comprises information about any one or more out of: preferred relay types of the second wireless device, incentive of assisting the second wireless device, type of help needed by the second wireless device, position information of the second wireless device, velocity information of the second wireless device, UE capability information of the second wireless device, group identity of the second wireless device, Home operator and/or visited operator of the second wireless device.

66. The method according to claim 61, wherein the second beacon signal comprises information about any one or more out of: link quality and/or signal strength to serving network node, relaying capability of the first wireless device, position information of the first wireless device, velocity information of the first wireless device, UE capability information of the first wireless device, group identity of whom the first wireless device is willing to provide relay assistance, home operator of the first wireless device, visited operator of the first wireless device.

67. A second wireless device for handling relay assistance from a first wireless device in a wireless network, the second wireless device comprising:
at least one of:
a sending unit adapted to send a first beacon signal to the first wireless device, which first beacon signal advertises that the second wireless device needs relay assistance in a radio communication; and
a receiving unit adapted to receive a second beacon signal from the first wireless device, which second beacon signal advertises that the first wireless device provides relay assistance in a radio communication in the wireless network; and
wherein the second wireless device further comprises a configuring unit adapted to configure a Device to Device (D2D) bearer between the first wireless device and the second wireless device based on the first beacon signal and/or the second beacon signal, thereby enabling said radio communication to be performed via the D2D bearer, wherein the first wireless device acts as a relay node.

68. The second wireless device according to claim 67, wherein the second wireless device is served by a network node, and wherein the sending unit further is adapted to send a report to the network node, which report comprises a measurement of the second beacon signal, and which measurement is performed by the second wireless device.

69. The second wireless device according to claim 67, wherein the receiving unit further is adapted to receive from the network node, the configuration of the D2D bearer between the first wireless device and the second wireless device, for enabling said communication to be performed via the D2D bearer.

70. The second wireless device according to claim 67, wherein the second wireless device is adapted to be served by or is camping on a network node, and
wherein the receiving unit further is adapted to measure on reference signals from the network node, one or more out of a Reference Signal Received Power (RSRP) Reference Signal Received Quality (RSRQ), and Received Signal Strength Indicator (RSSI), and
wherein the sending unit further is adapted to send the first beacon signal when any one of the RSRP, RSSI, and/or RSRQ measurements falls below a threshold.

71. The second wireless device according to claim 67, wherein the first beacon signal provides information about any one or more out of: preferred relay types of the second wireless device, incentive of assisting the second wireless device, type of help needed by the second wireless device, position information of the second wireless device, velocity information of the second wireless device, UE capability information of the second wireless device, group identity of the second wireless device, Home operator and/or visited operator of the second wireless device.

72. The second wireless device according to claim 67, wherein the second beacon signal provides information about any one or more out of: link quality and/or signal strength to serving network node, relaying capability of the first wireless device, position information of the first wireless device, velocity information of the first wireless device, UE capability information of the first wireless device, group identity of the first wireless device, home operator of the first wireless device, visited operator of the first wireless device.

73. The second wireless device according to claim 67,
wherein the receiving unit further is adapted estimate the pathloss between the second wireless device and the first wireless device on the second beacons signal, and to estimate the pathloss between second wireless device and the network node, and
the second wireless device further comprises a processor adapted to select the first wireless device as a candidate for providing relay assistance, when the estimated pathloss between the second wireless device and the first wireless device is lower compared to the estimated pathloss between the second wireless device and the network node.

74. The second wireless device according to claim 73,
wherein the processor adapted to determine that the first wireless device being a candidate shall provide relay assistance, if the candidate provides a route, from the second wireless device via the candidate to the network node, that has higher data rate than a route from the second wireless device direct to network node, and/or
wherein the sending unit further is adapted to send a report to the network node, which report comprises the pathloss between the second wireless device and the candidate for providing relay assistance.

75. The second wireless device according to claim 67, wherein the receiving unit further is adapted to receive one or more further second beacon signals from respective one or more further wireless devices, which respective one or more further second beacon signals advertise that the respective one or more further wireless devices provide relay assistance in the radio communication in the wireless network.

76. The second wireless device according to claim 75,
wherein the receiving unit further is adapted estimate the pathloss between the second wireless device and the respective one or more further wireless devices on the respective second beacons signals,
and wherein the processor further is adapted to select these any of the respective first wireless device and/or one or more further wireless devices as a respective candidate for providing relay assistance, when the estimated pathloss between the second wireless device and any of the respective first wireless device and/or one or more further wireless devices is lower compared to the estimated pathloss between the second wireless device and the network node.

77. The second wireless device according to claim 76,
wherein the processor further is adapted to determine that the candidate that provides a route with the highest data rate shall provide relay assistance, which route is from the second wireless device via the candidate to the network node, if that candidate provides a route that has higher data rate than a route from the second wireless device direct to network node, and/or
wherein the sending unit further is adapted to send a report to the network node, which report comprises the pathloss between the second wireless device and the respective candidates for providing relay assistance.

78. A network node for handling relay assistance by a first wireless device to a second wireless device in a wireless network, which second wireless device needs relay assistance in a radio communication, the network node comprising:
a receiving unit adapted to receive one or more reports from the first wireless device and/or the second wireless device, which one or more reports comprise a respective measurement of a beacon signal sent between the first wireless device and the second wireless device; and
a sending unit adapted to, when the measurement in the one or more reports exceeds a threshold, send to the first wireless device and the second wireless device, a configuration of a Device to Device (D2D) bearer between the first wireless device and the second wireless device, enabling said communication to be performed via the D2D bearer wherein the first wireless device acts as a relay node.

79. The network node according to claim 78,
wherein the receiving unit further is adapted to receive from the second wireless device, a report comprising the pathloss between the second wireless device and the first wireless device being a candidate for providing relay assistance, and
wherein the network node further comprises a processor, and wherein the measurement in the one or more reports exceeding a threshold is established by the processor, which processor is adapted to determine, based on the reported pathloss, that the first wireless device being a candidate shall provide relay assistance, if the candidate provides a route, from the second wireless device via the candidate to the network node, that has higher data rate than a route from the second wireless device direct to network node.

80. The network node according to claim 79,
wherein the receiving unit further is adapted to receive from the one or more further wireless devices, a respective report comprising the pathloss between the second wireless device and respective further wireless devices also being candidates for providing relay assistance, and
and wherein the measurement in the one or more reports exceeding a threshold is established by the processor, which processor is further adapted to determine that the candidate that provides a route with the highest data rate shall provide relay assistance, which route is from the second wireless device via the candidate to the network node if that candidate provides a route that has higher data rate than a route from the second wireless device direct to network node, based on the reported pathloss.

81. The network node according to claim 78, wherein the network node further comprises an allocating unit adapted to:
allocate a channel for the first beacon signal to be sent by the second wireless device, which first beacon signal advertises that the second wireless device requires relay assistance in the radio communication; and/or
allocate a channel for the second beacon signal to be sent by the first wireless device, which second beacon signal advertises that the first wireless device is capable of providing relay assistance in the radio communication in the wireless network.

82. The network node according to claim 78, wherein the configuration of the D2D bearer between the first wireless device and the second wireless device is adapted to involve one or more out of: reserving resources for the D2D link for a time period, notifying the first wireless device and the second wireless device about bearer establishment, and/or sending configuration parameters to the first wireless device and the second wireless device.

83. A first wireless device for handling relay assistance for a second wireless device in a wireless network, the first wireless device comprising:
at least one of:
a receiving unit adapted to receive a first beacon signal from the second wireless device, which first beacon signal advertises that the second wireless device needs relay assistance in a radio communication; and
a sending unit adapted to send a second beacon signal to be received by the second wireless device, which second beacon signal advertises that the first wireless device has capability to provide relay assistance in a radio communication in the wireless network; and
wherein the first wireless device further comprises a configuring unit adapted to configure a Device to Device (D2D) bearer between the first wireless device and the second wireless device based on the first beacon signal and/or the second beacon signal, thereby enabling said radio communication to be performed via the D2D bearer, wherein the first wireless device acts as a relay node.

84. The first wireless device according to claim 83, wherein the first wireless device is served by a network node, and wherein the sending unit further is adapted to send a report to the network node, which report comprises a measurement of the first beacon signal, and which measurement is performed by the first wireless device.

85. The first wireless device according to claim 83, wherein the receiving unit further is adapted to receive from a network node in the wireless network the configuration of the D2D bearer between the first wireless device and the second wireless device, for enabling said radio communication to be performed via the D2D bearer.

86. The first wireless device according to claim 83, wherein the first wireless device is served by or is camping on a network node, and
wherein the receiving unit further is adapted to measure on reference signals from the network node, one or more out of a Reference Signal Received Power (RSRP), Reference Signal Received Quality (RSRQ), and Received Signal Strength Indicator (RSSI), and
wherein the sending unit further is adapted to send the second beacon signal when any one of the RSRP, RSSI, and/or RSRQ measurements falls below a threshold.

87. The first wireless device according to claim 83, wherein the first beacon signal comprises information about any one or more out of: preferred relay types of the second wireless device, incentive of assisting the second wireless device, type of help needed by the second wireless device, position information of the second wireless device, velocity information of the second wireless device, UE capability information of the second wireless device, group identity of the second wireless device, Home operator and/or visited operator of the second wireless device.

88. The first wireless device according to claim 83, wherein the second beacon signal provides information about any one or more out of: link quality and/or signal strength to serving network node, relaying capability of the first wireless device, position information of the first wireless device, velocity information of the first wireless device, UE capability information of the first wireless device, group identity of whom the first wireless device is willing to provide relay assistance, home operator of the first wireless device, visited operator of the first wireless device.
